(19) United States
(12) Patent Application Publication
(10) Pub. No.: US 2007/0291855 A1
(43) Pub. Date: Dec. 20, 2007

(54) METHOD, DEVICE AND SYSTEM OF ERROR-PROTECTION OF A WIRELESS VIDEO TRANSMISSION

(76) Inventors: Zvi Reznic, Tel Aviv (IL); Meir Feder, Herzliya (IL); Shay Freundlich, Givat Ada (IL)

Correspondence Address: EITAN MEHULAL LAW GROUP, 116 JOHN ST,, SUITE 1201, NEW YORK, NY, 10038, US

(21) Appl. No.: 11/768,583

(22) Filed: Jun. 26, 2007

Related U.S. Application Data
(63) Continuation-in-part of application No. 11/613,053, filed on Dec. 19, 2006.
(60) Provisional application No. 60/752,155, filed on Dec. 19, 2005.
(60) Provisional application No. 60/806,410, filed on Jun. 30, 2006.

(51) Int. Cl. H04B 1/66

(52) U.S. Cl. 375/240.27; 375/E07.073

(57) ABSTRACT

Some demonstrative embodiments of the invention include devices, systems and/or methods of error-protection of a wireless video transmission. Some demonstrative embodiments of the invention include a wireless transmitter to transmit a wireless transmission including a data stream corresponding to at least a video signal. The data stream may include a plurality of data components, which are protected according to an unequal error protection scheme. At least first and second data components of the plurality of data components may be protected by first and second error protection mechanisms, respectively. Other embodiments are described and claimed.

### CROSS-REFERENCE

This application claims the benefit of U.S. Provisional Patent application 60/806,410, entitled “Method for encrypting wireless transmitted data”, filed Jun. 30, 2006; and is a Continuation In Part (CIP) of U.S. patent application Ser. No. 11/613,053, entitled “Apparatus and method for applying unequal error protection during wireless video transmission”, filed Dec. 19, 2006, which claims the benefit of US Provisional Patent application 60/752,155, entitled “An apparatus and method for unequal error protection of wireless video transmission”, filed Dec. 19, 2006, the entire disclosures of all of which are incorporated herein by reference.

### FIELD

Some embodiments relate generally to the filed of wireless communication and, more particularly, to wireless video communication.

### BACKGROUND

Wireless communication has rapidly evolved over the past decades. Even today, when high performance and high bandwidth wireless communication equipment is made available there is demand for even higher performance at a higher bandwidth.

In many houses, television and/or video signals are received through cable or satellite links at a Set-Top Box (STB) located at a fixed point. In many cases, it may be desired to place a screen at a location in a distance of at least a few meters from the STB. This trend is becoming more common as flat-screen displays, e.g., plasma or liquid crystal display (LCD) televisions are hung on a wall. Connection of such a display to the STB through cables is generally undesired for aesthetic reasons and/or installation convenience. Thus, wireless transmission of the video signals from the STB to the screen is preferred.

Typically, the video data is received at the STB in a compressed format in accordance, for example, with the Motion Picture Expert Group (MPEG) format, and decompressed by the STB to a high quality raw video signal. The raw video signal may be in an analog format or a digital format, such as the Digital Video Interface (DVI) format or the High Definition Multimedia Interface (HDMI) format. The digital formats typically have a High Definition Television (HDTV) data rate of up to about 1.5 Giga bits per second (Gbps).

Compression technologies made available through standard or non-standard specification may be implemented to allow wireless transmission of the raw video signal. Compression technologies include a variety of MPEG standard such as MPEG2, MPEG4, JPEG2000, wavelet technology, and the like. According to these technologies a transform is performed, for example a Discrete Cosine Transform (DCT), resulting in various coefficients representing the video signal.

Wireless conditions may change over time, becoming worse or better, depending on a plurality of reasons. The changing conditions may result in a degradation of the video signal, e.g., as conditions worsen.

### SUMMARY

Some demonstrative embodiments of the invention include devices, systems and/or methods of error-protection of a wireless video transmission.

Some demonstrative embodiments of the invention include a wireless transmitter to transmit a wireless transmission including a data stream corresponding to at least a video signal. The data stream may include a plurality of data components, which are protected according to an unequal error protection scheme, wherein at least first and second data components of the plurality of data components are protected by first and second error protection mechanisms, respectively.

According to some demonstrative embodiments of the invention, the first and second error protection mechanisms may include first and second types of error correction codes, respectively.

According to some demonstrative embodiments of the invention, the error correction code of the first type may be stronger than the error correction code of the second type.

According to some demonstrative embodiments of the invention, the first and second types of error correction codes may include error correction codes of first and second rates, respectively.

According to some demonstrative embodiments of the invention, the first and second error protection mechanisms may correspond to first and second different modulation schemes.

According to some demonstrative embodiments of the invention, the first and second modulation schemes may include first and second different numbers of constellation points.

According to some demonstrative embodiments of the invention, the first protection mechanism allows recovery of a larger number of erroneous bits than the second protection mechanism.

According to some demonstrative embodiments of the invention the first component may include a plurality of most-significant bits of a value corresponding to the video signal, and the second component may include a plurality of least-significant-bits of the value.

According to some demonstrative embodiments of the invention, a degree of protection provided by the first error protection mechanism is higher than a degree of protection provided by the second error protection mechanism. An importance level of the first data component may be higher than an importance level of the second data component.

According to some demonstrative embodiments of the invention, the first data component may include a quantized value of a transformation coefficient corresponding to the video signal. The second data component may include a quantization-error value corresponding to the quantized value.

According to some demonstrative embodiments of the invention, at least one of the first and second data components may be protected by a full error correction mechanism.

According to some demonstrative embodiments of the invention, at least one of the first and second data components may be protected by a partial error correction mechanism.

According to some demonstrative embodiments of the invention, at least one of the first and second data components may be protected by an error detection mechanism.

According to some demonstrative embodiments of the invention, the plurality of data components may include de-correlation components resulting from applying a de-correlation transformation to the video signal. The de-correlation transformation may include at least one of a discrete cosine transform and a wavelet.

According to some demonstrative embodiments of the invention, the first and second data components may be encrypted according to at least one encryption scheme.

According to some demonstrative embodiments of the invention, the first and second data components may be encrypted according to first and second different encryption schemes, respectively.

According to some demonstrative embodiments of the invention, the video signal may include a high-definition-television video signal. For example, the high-definition-television video signal may include an uncompressed high-definition-television video signal.

According to some demonstrative embodiments of the invention, the wireless transmission may include a multiple-input-multiple-output transmission.

According to some demonstrative embodiments of the invention, the wireless transmission may include an orthogonal-frequency-division-multiplexing transmission.

Some demonstrative embodiments of the invention include a wireless transmission system including a video source to generate a video signal; and a wireless transmitter to transmit a wireless transmission including a data stream corresponding to the video signal, the data stream including a plurality of data components, which are protected according to an unequal error protection scheme, wherein first and second data components of the plurality of data components are protected by first and second error protection mechanisms, respectively.

According to some demonstrative embodiments of the invention, the system may include a video destination; and a wireless receiver to receive the wireless transmission and to provide the video destination with an input corresponding to the transmitted video signal.

Some demonstrative embodiments of the invention include a wireless receiver to receive a wireless transmission including a data stream representing a video signal and to generate an output corresponding to the transmitted video signal. The data stream may include a plurality of data components, which are protected according to an unequal error protection scheme, wherein first and second data components of the plurality of data components are protected by first and second error protection mechanisms, respectively.

Some demonstrative embodiments of the invention include a method including transmitting a wireless transmission including a data stream corresponding to a video signal, the data stream including a plurality of data components, which are protected according to an unequal error protection scheme, wherein first and second data components of the plurality of data components are protected by first and second error protection mechanisms, respectively.

According to some demonstrative embodiments of the invention, the method may include receiving the wireless transmission; and generating an output corresponding to the transmitted video signal.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. Moreover, some of the blocks depicted in the drawings may be combined into a single function. The figures are listed below.

FIG. 1 is a schematic illustration of a wireless video communication system, in accordance with some demonstrative embodiments of the invention;

FIG. 2 is a schematic illustration of an encryptor, in accordance with some demonstrative embodiments of the invention;

FIG. 3 is a schematic illustration of a decryptor, in accordance with some demonstrative embodiments of the invention;

FIG. 4 is a schematic flow-chart illustration of a method of protecting a wireless video transmission, in accordance with some demonstrative embodiments of the invention; and

FIG. 5 is a schematic flow-chart illustration of a method of handling a received wireless video transmission, in accordance with some demonstrative embodiments of the invention.

### DETAILED DESCRIPTION

In the following detailed description, numerous specific details are set forth in order to provide a thorough understanding of some embodiments of the invention. However, it will be understood by persons of ordinary skill in the art that embodiments of the invention may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing,” “computing,” “calculating,” “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term, “plurality” may be used throughout the specification to describe two or more components, devices, elements, parameters and the like.

It should be understood that some embodiments of the invention may be used in a variety of applications. Although embodiments of the invention are not limited in this respect, one or more of the methods, devices and/or systems disclosed herein may be used to protect wireless video signals, for example, High-Definition-Television (HDTV) signals, communicated between a video source and a video destination.

Although embodiments of the invention are not limited in this respect, the video signals may include signals of any suitable format, e.g., compressed video signals or substantially uncompressed video signals. The compressed video signals may be compressed, for example, in accordance with a MPEG standard such as MPEG2, MPEG4, JPEG2000, wavelet technology, and the like.

Although embodiments of the invention are not limited in this respect, the term “Unequal Error Protection (UEP) scheme” as used herein may relate to a protection scheme including a plurality of different error protection mechanisms to be selectively applied to a plurality of data components of a wireless transmission, based on any suitable error-protection criteria. The error protection mechanisms may include any suitable method, algorithm, configuration, protocol, procedure, and/or process to enable detecting and/or correcting an error in a received wireless transmission. The plurality of error protection mechanisms may differ from one another in any suitable one or more parameters, including but not limited to an error-protection strength level, a modulation scheme, a type of an Error-Correction-Code (ECC), an ECC rate, an ability to recover erroneous bits, and the like, e.g., as described below.

According to some demonstrative embodiments of the invention, wireless transmission of video, e.g., high-definition video, whether essentially uncompressed or compressed, may be prone to errors during transmission and/or reception due, for example, to a condition of a wireless link used for the transmission.

Some demonstrative embodiments of the invention may be implemented to assure that at least some portions or components of the video transmission, e.g., portions of the video transmission representing relatively important components of the video signal, e.g., lower special frequencies and/or Most Significant Bits (MSBs), are protected to ensure correct reception and/or reconstruction of the video signal. Bandwidth limitations of the wireless link may affect the amount of data that may be sent over the wireless link. Accordingly, using a protection mechanism of a high-level error recovery for substantially all data components representing the video signal may not be efficiently feasible.

According to some demonstrative embodiments of the invention, an UEP scheme may be applied to the data components to provide different error protection levels to the different data components, e.g., as described below. In one example, a higher level of error protection may be provided to data components of a higher importance level, as described in detail below.

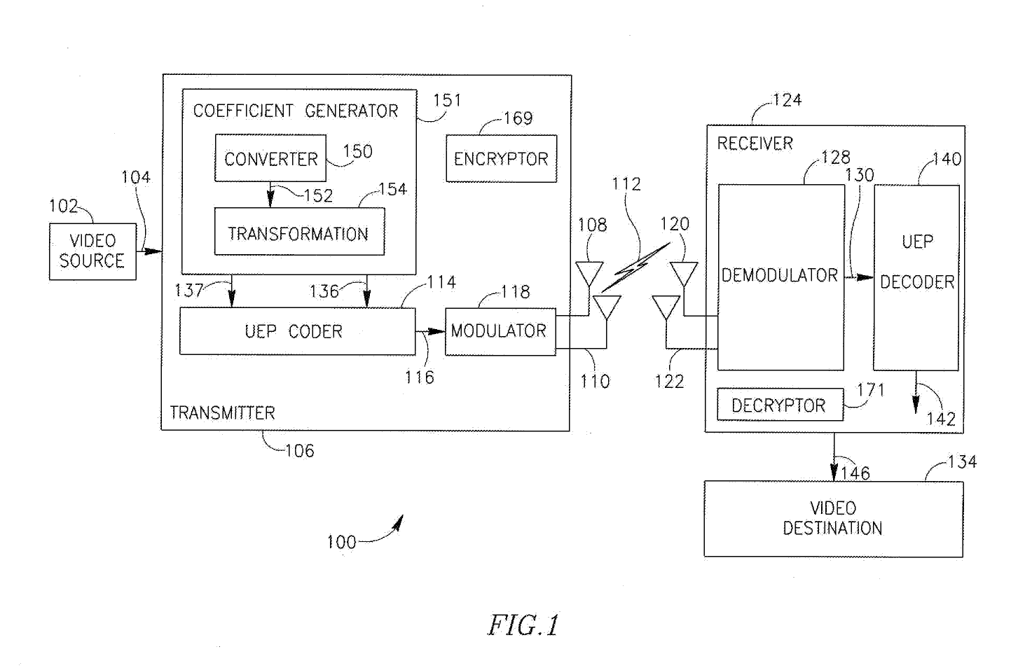

Reference is made to FIG. 1, which schematically illustrates a wireless video communication system 100, in accordance with some demonstrative embodiments of the invention.

According to some demonstrative embodiments of the invention, system 100 may include a wireless transmitter 106 to transmit a wireless video transmission 112 based at least on an input video signal 104 received from a video source 102. Video source 102 may include any suitable software and/or hardware to generate video signal 104, e.g., as described below.

According to some demonstrative embodiments of the invention, transmission 112 may include a data stream, e.g., including a plurality of data components 116, which may be protected according to an UEP scheme. For example, at least first and second data components of transmission 112 may be protected by at least first and second different error protection mechanisms, respectively, e.g., as described in detail below.

According to some demonstrative embodiments of the invention, transmitter 106 may include a UEP coder 114 to generate data components 116 by applying the UEP scheme to a plurality of data components 136 corresponding to video signal 104, e.g., as described below.

According to some demonstrative embodiments of the invention, the first protection mechanism may allow recovery of a larger number of erroneous bits than the second protection mechanism, e.g., as described below.

According to some demonstrative embodiments of the invention, the first and second error protection mechanisms may include first and second types of Error Correction Codes (ECCs), respectively, e.g., as described below. In one example, the ECC of the first type may be stronger than the ECC of the second type. In another example, the ECCs of the first and second types may have first and second ECC rates, respectively, e.g., as described below.

According to some demonstrative embodiments of the invention, the first and second error protection mechanisms may correspond to first and second different modulation schemes, respectively, e.g., as described below.

According to some demonstrative embodiments of the invention, transmitter 106 may include a modulator 118 to modulate data components 116 according to any suitable modulation scheme. Transmitter 106 may include one or more antennas, e.g., antennas 108 and 110, to transmit transmission 112 including data components 116. Transmitter 106 may implement any suitable transmission method and/or configuration to transmit transmission 112. Although embodiments of the invention are not limited in this respect in, some demonstrative embodiments of the invention, transmitter 106 may generate transmission 112 according to an Orthogonal-Division-Frequency-Multiplexing (OFDM) modulation scheme. According to other embodiments, transmitter 106 may generate transmission 112 according to any other suitable modulation and/or transmission scheme.

According to some demonstrative embodiments of the invention, transmission 112 may include a Multiple-Input-Multiple-Output (MIMO) transmission. For example, modulator 118 may modulate data components 136 according to a suitable MIMO modulation scheme.

According to some demonstrative embodiments of the invention, system 100 may also include a wireless receiver 124 having one or more antennas, e.g., antennas 120 and 122, to receive transmission 112. Receiver 124 may demodulate transmission 112, and generate an output video signal 146 including a stream of data components 142, e.g., corresponding to video signal 104. Video signal 146 may be provided to a video destination module 134, which may include any suitable software and/or hardware to handle video signal 146 in any suitable manner, e.g., as described below.

According to some demonstrative embodiments of the invention, receiver 124 may implement any suitable reception method and or configuration to receive transmission 112. Although embodiments of the invention are not limited in this respect, in some demonstrative embodiments of the invention, receiver 124 may receive and/or demodulate transmission 112 according to an OFDM modulation scheme. According to other embodiments, receiver 124 may receive and/or demodulate transmission 112 according to any other suitable modulation and/or transmission scheme.

According to some demonstrative embodiments of the invention, receiver 124 may include a demodulator to 128 to demodulate transmission 112 into a stream of a plurality of protected data components 130 protected according to the UEP scheme, e.g., corresponding to components 116. According to some demonstrative embodiments of the invention, demodulator 128 may demodulate transmission 112 according to a suitable MIMO demodulation scheme.

According to some demonstrative embodiments of the invention, receiver 124 may include an UEP decoder 140 to decode protected data components 130 into data components 142 according to a UEP scheme corresponding, for example, to the UEP scheme implemented by UEP coder 114, e.g., as described in detail below.

Although embodiments of the invention are not limited in this respect, in some demonstrative embodiments video signal 104 may include a video signal of any suitable video format. In one example, signal 104 may include HDTV video signal, for example, a compressed or substantially uncompressed HDTV signal, e.g., in a Digital Video Interface (DVI) format, a High Definition Multimedia Interface (HDMI) format, or any other suitable video format. According to these embodiments, video source module 102 may include, for example, a set-top box, a computer, a game console, a Video Cassette Recorder (VCR), a Digital Video Disc (DVD), and the like. Video destination Module 134 may include, for example, a display or screen, e.g., a flat screen display, a Liquid Crystal Display (LCD), a plasma display, a television, and the like. Accordingly, transmission 112 may include, for example, a HDTV video transmission. In other embodiments, video signal 104 may include any other suitable video signal, and/or source 102 and/or destination 134 may include any other suitable video modules.

Although embodiments of the invention are not limited in this respect, types of antennae that may be used for antennas 108, 110, 120 and/or 122 may include but are not limited to internal antenna, dipole antenna, omni-directional antenna, a monopole antenna, an end fed antenna, a circularly polarized antenna, a micro-strip antenna, a diversity antenna and the like.

According to some demonstrative embodiments of the invention, data components 136 may correspond to a plurality layers and/or levels of importance. The importance level of a data component may be based, for example, on a degree of contribution of the data component to representing video signal 104 and/or to the reconstruction of video signal 104 at receiver 124. The degree of contribution of the data component may be related, for example, to a quality reduction in the video signal resulting from an error in the data component as received by receiver 124. An importance level of the data component may be high if, for example, an error in the data component will result in a large quality reduction in video signal 146, e.g., compared to video signal 104. For example, a first data component of data components 136 may have an importance level higher than an importance level of a second data component of data components 136 if, for example, the contribution of the first data component to a quality of video signal 104 is greater than a contribution of the second data component.

Although embodiments of the invention are not limited in this respect, according to some demonstrative embodiments of the invention data components 136 may include at least a plurality of coefficients corresponding to video signal 104. For example, transmitter 106 may include a coefficient generator 151 to generate data components 136 including a plurality of transformation coefficients representing video signal 104, e.g., as described below.

According to some demonstrative embodiments of the invention, coefficient generator 151 may apply any suitable transformation function to video signal 104, for example, a Discrete Cosine Transform (DCT), a wavelet, or the like.

In one example, coefficient generator 151 may generate the transformation coefficients by applying a de-correlating transformation, e.g., a DCT and/or a wavelet, to video signal 104, e.g., as described in U.S. patent application Ser. No. 11/551,641, entitled “Apparatus and method for uncompressed, wireless transmission of video”, filed Oct. 20, 2006, and published May 3, 2007, as US Patent Application Publication US 2007-0098063 (“the '641 Application”), the entire disclosure of which is incorporated herein by reference. For example, coefficient generator 151 may include a transform unit 154 to perform the de-correlating transform on a plurality of color components 152, e.g., in the format Y—Cr—Cb, representing pixels of video signal 104, as described in the '641 application. Transmitter 106 may optionally include a color converter 150 to convert color components of video signal 104, e.g., in a Red-Green-Blue (RGB) format, into color components 152, e.g., as described in the '641 application. Although embodiments of the invention are not limited in this respect, in some embodiments data components 136 may include values of fine constellation symbols, and values of coarse constellation symbols, e.g., as described in the '641 application.

According to some demonstrative embodiments of the invention, data components 136 may include a plurality of coefficients of different importance levels. In one example, data components 136 may include transformation coefficients of different frequencies, e.g., if the transformation includes a DCT. Coefficients of lower frequencies may be associated with an importance level higher than an importance level of coefficients of higher frequencies. In another example, data components 136 may include coefficients of different strengths, e.g., if the transformation includes a wavelet. Stronger wavelet coefficients may be associated, for example, with an importance level higher than an importance level of weaker coefficients. In other examples, data components 136 may be associated with a plurality of importance levels according to any other suitable criteria. For example, the importance levels may be defined in accordance with a compression standard, e.g., the JPEG2000 compression standard if, for example, data components 136 include data components corresponding to a compressed video signal.

According to some demonstrative embodiments of the invention, a value of a data component of data components 136 may be represented by a plurality of bits, e.g., eight bits. For example, the transformation coefficients generated by coefficient generator 151 may each be represented by an n-bit value, wherein n is a positive integer, e.g., n=8.

According to some demonstrative embodiments, two or more portions of the n-bit value may be protected by two or more different protection mechanisms. For example, the plurality of bit representing a value of data components 136 may include two or more groups of bits associated with two or more different importance levels, respectively. In one example, the plurality of bits may include a first group of one or more, e.g., four, MSBs, and a second group of one or more, e.g., four, LSBs. In another example, the plurality of groups may include three or more groups of bits, e.g., a first group including one or more, e.g., two, MSBs; a second group including one or more, e.g., two, second-significant bits following the MSBs; a third group of one or more, e.g., two third-significant bits following the second-significant bits; and a fourth group of one or more, e.g., two, LSBs.

According to some demonstrative embodiments of the invention, the plurality of groups of bits representing the value of the data component may be associated with a plurality of importance levels based, for example, on the bit-significance level. For example, the group of MSBs may be associated with a first importance level higher than a second importance level of the second-significant bits, which in turn may be higher than a third importance level of the third-significant bits, which in turn may be higher than a fourth importance level of the LSBs.

According to some demonstrative embodiments of the invention, the UEP scheme implemented by UEP coder 114 may apply a plurality of different protection mechanisms to data components 136 based, for example, on the importance level of components 136. For example, UEP may receive, e.g., from coefficient generator 151, an indication 137 to indicate the importance levels associated with components 136.

According to some demonstrative embodiments of the invention, UEP 114 may apply at least first and second different protection mechanisms to at least first and second components of data components 136, respectively, based, for example, on first and second importance levels of the first and second components, respectively.

According to some demonstrative embodiments of the invention, the first and second protection mechanisms may allow recovery and/or reconstruction, e.g., at receiver 124, of first and second different numbers of erroneous bits, respectively. For example, UEP 114 may protect the first data component with a first protection mechanism allowing recovery of a larger number of erroneous bits than the second protection mechanism if, for example, the importance level of the first data component is higher than the importance level of the second data component.

According to some demonstrative embodiments of the invention, one or more of the plurality of protection mechanisms applied to data components 136 by UEP 114 may include an ECC. UEP 114 may protect one or more of data components 136, for example, by ECCs of one or more types. For example, UEP 114 may protect the first and second data components by first and second types of ECCs, respectively. In one example, the ECC of the first type may be stronger than the ECC of the second type, e.g., if the importance level of the first data component is higher than the importance level of the second data component.

According to some demonstrative embodiments, the strength of the ECC may be based, for example, on the number of erroneous bits, which may be recovered or reconstructed from a transmission encoded by the ECC. For example, the ECC of the first type may be stronger than the ECC of the second type if, for example, the ECC of the first type may enable reconstructing a first number of erroneous bits bigger than a second number of erroneous bits, which may be reconstructed using the ECC of the second type.

According to some demonstrative embodiments of the invention, the ECCs of one or more types may include ECCs having one or more different ECC rates. Although embodiments of the invention are not limited in this respect, the term “ECC rate” as used herein may relate to a ratio between a number of bits protected by an ECC code (“protected bits”), and a sum of the number of protected bits and a number of bits in the ECC code. For example, a protection scheme implementing an ECC code of 250 bits to protect 1000 bits, may have an ECC rate of 1000/(1000+250)=0.8. A lower ECC rate may correspond, for example, to a stronger ECC since, for example, a stronger ECC may include an ECC code of a larger number of bits compared to an ECC code of a weaker ECC.

According to some demonstrative embodiments of the invention, UEP 114 may apply to the first and second data components ECCs of first and second ECC rates, respectively. In one example, the first ECC rate may be lower than the second ECC rate, e.g., if the importance level of the first data component is higher than the importance level of the second data component.

According to some demonstrative embodiments of the invention, one or more of the plurality of protection mechanisms applied to data components 136 by UEP 114 may correspond to one or more parameters of a modulation scheme used for modulating the data components. For example, UEP 114 may protect the first and second data components by protection schemes corresponding to first and second different modulation schemes, respectively. In one example, the degree of protection provided by a protection scheme corresponding to a modulation scheme may correspond to a number of constellation points defined by the modulation scheme. For example, the smaller the number of constellation points in a modulation scheme the bigger the distance between the constellation points, e.g., on a constellation map. Accordingly, a smaller number of constellation points may result in a lower error probability. Therefore, the first protection scheme may provide a higher level of protection compared to the second protection scheme if, for example, the number of constellation points in the first modulation scheme is smaller than the number of constellation points in the second modulation scheme.

According to some demonstrative embodiments, UEP 114 and/or modulator 118 may protect one or more data components of a first importance level using a first modulation scheme including a first number of constellation points; and one or more data components of a second importance level using a second modulation scheme including a second number of constellation points. The number of constellation points in the first modulation scheme may be smaller than the number of constellation points in the second modulation scheme. In one example, the first modulation scheme may include four constellation points, e.g., the first modulation scheme may include a Quadrature Phase-Shift Keying (QPSK) modulation; and/or the second modulations scheme may include more than four constellation points, e.g., the second modulation scheme may include a 16-Quadrature Amplitude Modulation (QAM) modulation. The first modulation scheme may be applied to protect data components of data components 136 having a first importance level, and the second modulation scheme may be applied to protect data components of data components 136 having a second importance level. The first importance level may be higher, for example, than the second importance level. For example, the first and second data components may include one or more MSBs and one or more LSBs, respectively, representing a value e.g., as described above.

According to some demonstrative embodiments of the invention, one or more of the plurality of protection mechanisms applied to data components 136 by UEP 114 may include one or more error detection schemes. The error detection schemes may be applied, for example, to data components associated with a relatively low importance level. For example, UEP decoder 140 may discard a received data component protected according to the error detection scheme if, for example, an error is detected in the received data component.

According to some demonstrative embodiments of the invention, a level of noise over the transmission channel of transmission 112 may vary, e.g., due to fading. Accordingly, the amount of data components of transmission 112, which may be reconstructed by receiver 124 may depend on the magnitude of the fading. For example, in a case of weak fading, substantially most or all of data components 136 may be reconstructed by receiver 124 since, for example, the noise does not affect substantially all data components, e.g., including the data components of low importance. In a case of stronger fading, some of the data components, e.g., data components associated with relatively low importance levels may not be reconstructed, while data components associated with higher importance levels may be reconstructed.

Although embodiments of the invention are not limited in this respect, according to some demonstrative embodiments of the invention the UEP scheme implemented by UEP coder 114 may include three protection mechanisms to be applied to data components 136 according to three respective important levels. In one example, the UEP scheme may include the following protection mechanisms:

TABLE 1

| Importance level | Protection mechanism |
|---|---|
| Most important components | Full error correction |
| Important components | Partial error correction |
| Least important components | Error detection |

A shown in Table 1, the data components may be associated with three importance levels. For example, the data components of the highest importance level may include high important transform coefficients and/or MSBs of the values of the data components; the data components of the second importance level may include medium importance transform coefficients and/or second-significant bits of the values of the data components; and/or the data components of the lowest importance level may include low importance transform coefficients and/or LSBs of the values of the data components. The data components of the highest importance may be protected by a protection mechanism implementing a full error correction mechanism. The full error correction mechanism may implement an ECC of a relatively low ECC rate, e.g., having a relatively large number of correction bits. The full error correction mechanism may allow correcting a relatively large number of errors in a received data component. The data components of the second importance level may be protected by a protection mechanism implementing a partial error correction mechanism. The partial error correction mechanism may implement an ECC of a relatively high ECC rate, e.g., having a relatively small number of correction bits. The partial error correction mechanism may allow correcting a relatively small number of errors in a received data component. The data components of the lowest importance level may be protected by a protection mechanism implementing an error detection mechanism. The error detection mechanism may allow detection of an error, e.g., without the capability of correcting the error.

Although embodiments of the invention are not limited in this respect, according to some demonstrative embodiments transmitter 106 may also include an encryptor 169 to encrypt protected data components 116 according to at least one encryption scheme; and receiver 124 may include a decryptor 171 to decrypt protected data components 130 according to the at least one encryption scheme. In one example, encryptor 169 may use the same encryption scheme to encrypt data components protected according to two or more protection mechanisms. In another example, encryptor 169 may use two or more different encryption schemes to encrypt data components protected according to two or more different protection mechanisms, e.g., as described in detail below.

According to some demonstrative embodiments of the invention, encryptor 169 may generate a plurality of encrypted streams by encrypting a plurality of respective streams in accordance with a plurality of encryption schemes. The plurality of streams may include, for example, data components 116 protected by a plurality of respective protection mechanisms, e.g., as described in detail below.

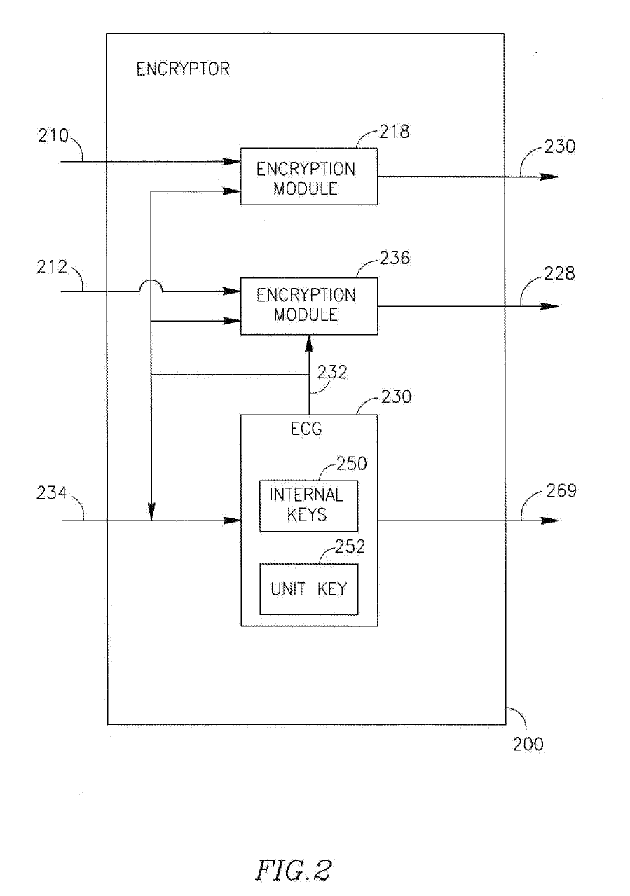

Reference is now made to FIG. 2, which schematically illustrates an encryptor 200, in accordance with some demonstrative embodiments of the invention. Although embodiments of the invention are not limited in this respect, according to some demonstrative embodiments of the invention, encryptor 200 may perform the functionality of encryptor 169 (FIG. 1).

According to some demonstrative embodiments of the invention, encryptor 200 may generate a plurality of encrypted streams, e.g., including streams 230 and/or 228, by encrypting a plurality of respective streams, e.g., including streams 210 and/or 212, in accordance with a plurality of encryption schemes, e.g., as described in detail below.

According to some demonstrative embodiments of the invention, encryptor 200 may include a plurality of encryption modules to implement the plurality of encryption schemes, respectively. Encryptor 200 may include, for example, a first encryption module 218 to implement a first encryption scheme, and a second encryption module 236 to implement a second encryption scheme. For example, encryption module 218 may encrypt stream 210 into encrypted stream 220 using the first encryption scheme; and encryption module 236 may encrypt stream 212 into encrypted stream 228 using the second encryption scheme.

Although embodiments of the invention are not limited in this respect, according to some demonstrative embodiments of the invention streams 210 and 212 may include data components protected according to first and second protection mechanism, respectively, e.g., data components 116 (FIG. 1), as described above. According to these embodiments, encrypted stream 220 may include data components protected according to the first protection mechanism and encrypted according to the first encryption scheme, and encrypted stream 224 may include data components protected according to the second protection mechanism and encrypted according to the second encryption scheme.

According to some demonstrative embodiments of the invention, encryption modules 218 and 236 may use one or more encryption codes 232 to encrypt stream 210. For example, encryptor 200 may include at least one Encryption Code Generator (ECG) 230 to generate encryption codes 232, e.g., as described in detail below.

According to some demonstrative embodiments of the invention, encryption codes 232 may include any suitable random or pseudo-random values, e.g., represented by a sequence of bits. In one example, ECG 230 may generate encryption codes 232 in accordance with any suitable block cipher technique, method or scheme, e.g., as defined by the Data Encryption Standard (DES), the Advanced Encryption Standard (AES), and the like.

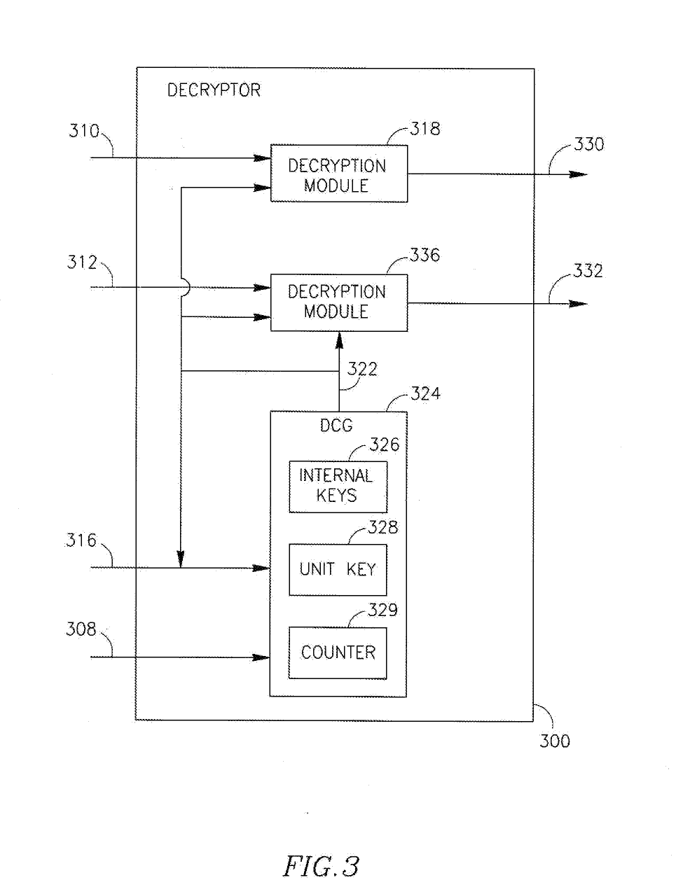

According to some demonstrative embodiments of the invention, ECG 230 may generate encryption codes 232 in synchronization with encryption codes implemented by a receiver (“the intended receiver”) intended to receive a transmission including streams 230 and 228, e.g., as described in detail below with reference to FIG. 3.

According to some demonstrative embodiments of the invention, ECG 230 may generate encryption codes 232 based on a plurality of internal keys 250, a unit key 252, and an initial value 234. Keys 250 and 252, and initial value 234 may include any suitable values, e.g., represented by a sequence of bits. In one example, ECG 230 may maintain internal keys 250 in the form of a table.

According to some demonstrative embodiments of the invention, a value of unit key 252 may match a value of a unit key implemented by the intended receiver, e.g., as described in detail below with reference to FIG. 3. The value of unit key 252 may be coordinated with the intended receiver using any suitable key exchange mechanism, e.g., in accordance with the Rivest-Shamir-Adleman (RSA) public key cipher, the Diffie-Hellman key exchange protocol, and the like.

According to some demonstrative embodiments of the invention, ECG 230 may generate encryption code 232 by encrypting initial value 234 using an encryption key resulting from a combination of unit key 252 and a selected internal key of internal keys 252. Encryption code 232 may be fed back as an input to ECG 230, such that additional codes 232 may be generated using a previous encryption code, e.g., instead of initial value 234. ECG 230 may select the selected internal key based on any suitable key selection criterion. For example, ECG 230 may re-select the internal key after a predefined number of frames, as described below.

Although some demonstrative embodiments of the invention are described above with reference to an encryptor, e.g., encryptor 200, including an ECG to generate encryption codes, e.g., encryption codes 232, to be provided to plurality encryption modules, e.g., encryption modules 218 and 236, in other embodiments of the invention the encryptor may include any other suitable configuration. For example, the encryptor may include a plurality of ECGs to generate the encryption codes of the plurality of encryption modules. In one example, at least first and second ECGs may generate at least first and second respective pluralities of encryption codes to be provided to the encryption modules.

According to some demonstrative embodiments of the invention, encryption module 218 may implement a first encryption scheme, e.g., to encrypt the data components of stream 210, and encryption module 236 may implement a second encryption scheme different than the first encryption scheme, e.g., to encrypt the data components of stream 212, as described in detail below.

According to some demonstrative embodiments of the invention, the encryption scheme implemented by encryption module 236 to encrypt stream 212 may include, for example, performing a logical operation on stream 212 using encryption code 232. In one example, performing module 236 may perform a logical Boolean operator, e.g., an Exclusive-OR (XOR) operation, between encryption code 232 and stream 212.

According to some demonstrative embodiments of the invention, the encryption scheme implemented by encryption module 218 to encrypt stream 210 may include, for example, performing a scrambling operation to scramble an order of the symbols of stream 210. Encryption module 218 may scramble the data components of stream 210, for example, by applying a random or pseudo-random permutation to the data components. For example, encoding module 218 may write chunks of a predefined number of the data components into a memory or buffer in a first permutation, and reading the chunks according to a second permutation, e.g., different than the first permutation. The first and second permutations may be determined, for example, according to encryption codes 232.

According to some demonstrative embodiments of the invention, the encryption scheme implemented by encryption module 218 to encrypt stream 210 may include, for example, inverting one or more of the values of the data components. For example, real or/and imaginary components may be multiplied either by −1 or +1 based, for example, on encryption codes 232.

According to some demonstrative embodiments of the invention, the encryption scheme implemented by encryption module 218 to encrypt stream 210 may include, for example, changing the phase of a complex value of a data component based on encryption code 232. For example, the complex value may be multiplied by e^{jα}, wherein the value of the phase α may be determined based on encryption code 232.

According to some demonstrative embodiments of the invention, ECG 230 may generate encryption information 269 related to encryption code 232. Encryption information 269 may be transmitted as part of a wireless transmission of streams 230 and 228. For example, Encryption information 269 may include one or more values to enable the intended receiver to synchronize a decryption code used to decrypt the wireless transmission with encryption code 232, e.g., as described below. In one example, encryption information 269 may include an Initial Value Offset (IVO), a key index, and a key index offset, e.g., as are described below.

According to some demonstrative embodiments of the invention, ECG 230 may use a different initial value 234, e.g., for encrypting different video frames. The initial value may be incremented with respect to a previous initial value, for example, according to a value of the IVO. ECG 230 may select the selected internal key of internal keys 250, based for example, on the value of the key index. The selection of the internal key may be performed after a number of frames defined by the key index offset. Encryption information 269 may be included, for example, by modulator 118 (FIG. 1) as part of one or more frames of the wireless transmission.

According to some demonstrative embodiments of the invention, the encryption scheme implemented by encryption module 218 to encrypt stream 210 may include any other suitable encryption scheme. For example, the encryption scheme may include a combination of two or more of the encryption schemes described above.

Reference is now made to FIG. 3, which schematically illustrates a decryptor 300, in accordance with some demonstrative embodiments of the invention. Although embodiments of the invention are not limited in this respect, according to some demonstrative embodiments decryptor 300 may perform the functionality of decryptor 171 (FIG. 1).

According to some demonstrative embodiments of the invention, decryptor 300 may generate a plurality of decrypted streams, e.g., streams 330 and/or 335, by decrypting a plurality of streams of a received transmission, e.g., streams 319 and 312, as described in detail below. Steams 310 and 312 may include for example, encrypted protected data components of streams 230 and 232 (FIG. 2), respectively.

According to some demonstrative embodiments of the invention, decryptor 300 may include a plurality of decryption modules to decrypt the plurality of streams based on a plurality of decryption schemes. The plurality of decryption schemes may correspond to the plurality of encryption schemes implemented to encrypt the received transmission, e.g., as are described above. Decryptor 300 may include, for example, a first decryption module 318 to decrypt stream 310 into decrypted stream 330 using a first decryption scheme; and a second decryption module 320 to decrypt stream 312 into decrypted stream 332 using a second decryption scheme.

According to some demonstrative embodiments of the invention, decryptor 300 may receive, e.g., from demodulator 128 (FIG. 1), encryption information 308 corresponding to encryption codes used for encrypting streams 310 and 312. Encryption information 308 may correspond, for example, to encryption information 269 (FIG. 2). For example, encryption information 308 may include the IVO, key index, and key index offset. In one example, encryption information 308 may be extracted, e.g., by demodulator 128 (FIG. 1), from frame headers of the received transmission, e.g., from substantially each frame header.

According to some demonstrative embodiments of the invention, decryption modules 318 and 320 may use one or more common decryption codes 322 to decrypt streams 310 and/or 312. For example, decryptor 300 may include at least one Decryption Code Generator (DCG) 324 to generate decryption codes 322, e.g., as described in detail below.

According to some demonstrative embodiments of the invention, decryption codes 322 may include any suitable random or pseudo-random value, e.g., represented by a sequence of bits. In one examples DCG 324 may generate decryption codes 322 in accordance with any suitable block cipher technique, method or scheme, e.g., as defined by the DES, the AES, and the like.

According to some demonstrative embodiments of the invention, DCG 324 may generate decryption codes 322 in synchronization with encryption codes implemented, e.g., by transmitter 200 (FIG. 2), for generating the received transmission, e.g., as described in detail below.

According to some demonstrative embodiments of the invention, DCG 324 may generate decryption codes 322 based on a plurality of internal keys 326, a unit key 328, and an initial value 316. Keys 326 and 328, and initial value 316 may include any suitable values, e.g., represented by a sequence of bits. In one example, DCG 324 may maintain internal keys 326 in the form of a table. Internal keys 326 may be identical, for example, to internal keys 250 (FIG. 2).

According to some demonstrative embodiments of the invention, a value of unit key 328 may match a value of a unit key implemented for generating the received transmission. For example, the value of unit key 328 may be coordinated, e.g., by receiver 124 and/or transmitter 106 (FIG. 1), with unit key 250 (FIG. 2), using any suitable key exchange mechanism, e.g., in accordance with the RSA public key cipher, the Diffie-Hellman key exchange protocol, and the like.

According to some demonstrative embodiments of the invention, DCG 324 may generate encryption code 322 by encrypting initial value 316 using an encryption key resulting from a combination of unit key 328 and a selected internal key of internal keys 326. Decryption code 322 may be fed back as an input to DCG 324, such that additional codes 322 may be generated using a previous decryption code, e.g., instead of initial value 316. DCG 324 may select the selected internal key based on any suitable key selection criterion. For example, DCG 324 may re-select the internal key after a predefined number of frames, as described below. In one example, DCG 324 may re-select the internal key based on a frame counter 329, which may count down from a value corresponding to the key index offset, e.g., as described below.

According to some demonstrative embodiments of the invention, decryption module 318 may implement a first decryption scheme, e.g., to decrypt stream 310, and decryption module 320 may implement a second decryption scheme different than the first decryption scheme, e.g., to decrypt stream 312, e.g., as described in detail below.

According to some demonstrative embodiments of the invention, the decryption scheme implemented by decryption module 320 to decrypt stream 312 may include, for example, performing a logical operation on stream 312 using decryption code 322. The logical operation may correspond, for example, to the logical operation performed by encryption module 236 (FIG. 2). In one example, decryption module 320 may perform a logical Boolean operator, e.g., an Exclusive-OR (XOR) operation, between decryption code 322 and stream 312.

According to some demonstrative embodiment of the invention, the decryption scheme implemented by decryption module 318 to decrypt stream 310 may include, for example, performing a decryption operation on stream 310 using decryption code 322. The decryption operation may correspond, for example, to the encryption scheme implemented for encrypting symbols of stream 310, e.g., the encryption scheme implemented by encryption module 218 (FIG. 2) to encrypt stream, 210 (FIG. 2), as described above.

According to some demonstrative embodiments, a method of synchronizing encryption information may be implemented to synchronize between an ECG, e.g., ECG 230 (FIG. 2), and a DCG, e.g., DCG 344, such that the DCG and ECG generate a decryption code, e.g., decryption code 322, in synchronization with an encryption code, e.g., encryption code 232 (FIG. 2).

According to some demonstrative embodiments, the method may include setting a unit value of the ECG and a unit value of the DCG to an identical value. Setting the unit values may include, for example, using any suitable key exchange mechanism, e.g., in accordance with the RSA public key cipher, the Diffie-Hellman key exchange protocol, and the like. The method may also include extracting encryption information from a received transmission. The encryption information may be extracted, for example, from a header of a received frame. The encryption information may include, for example, IVO, key index, and key index offset values, as are described above with reference to FIG. 2. For example, the encryption information may include the IVO, key index and key index offset values used for encrypting the received frame. The method may also include initializing the DCG. For example, the DCG may be initialized with an initial value, a key index, and a unit key. For example, DCG 324 may be initialized with unit key 328, initial value 316, and the key index, as described above. Initializing the DCG may also include, for example, initializing a frame counter to the value of the key index offset. For example, DCG 324 may initialize frame counter 329 according to the key index offset of encryption information 308. The method may also include incrementing the initial value by a value of the IVO extracted from the received frame, e.g., upon receiving each frame. The method may also include decrementing the frame counter, e.g., by one, for example, upon receiving each frame. The method may include determining whether the frame counter reached a predefined threshold value, e.g., zero. The method may include advancing the key index and resetting the frame counter to the key index value, e.g. if the frame counter has reached the threshold value. The method may also include comparing the key index and initial value of the DCG with the key index and initial value extracted from the received frame. The method may also include incrementing an error counter, e.g., by one, if for example, the key index and initial value of the DCG do not match the key index and initial value extracted from the received frame. The error counter may indicate the number of frames in which the DCG and ECG do not use synchronized encryption and decryption codes. The method may also include determining whether the error counter reaches a predefined error threshold. The method may also include resetting the error counter, e.g., to zero and re-initializing the DCG, e.g., as described above, if the error counter has reached the error threshold.

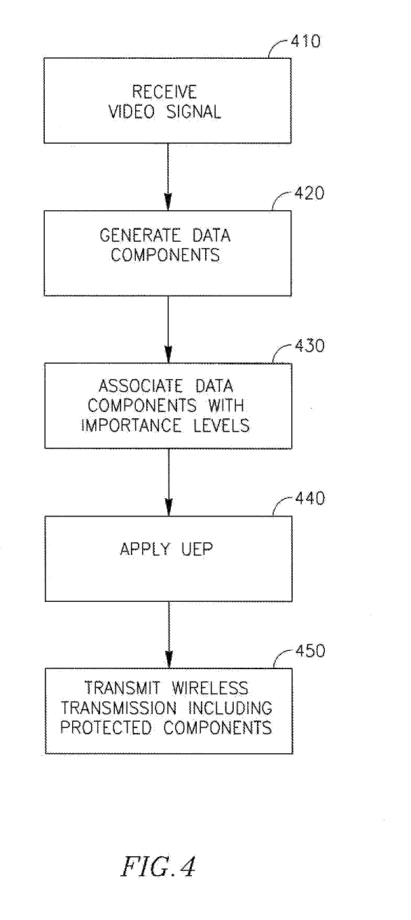

Reference is now made to FIG. 4, which schematically illustrates a method of protecting a wireless video transmission, in accordance with some demonstrative embodiments of the invention. Although embodiments of the invention are not limited in this respect, one or more operations of the method of FIG. 4 may be performed by a transmitter, e.g., transmitter 106 (FIG. 1), and/or a UEP coder, e.g., UEP coder 114 (FIG. 1), to protect data components of a wireless video transmission, e.g., transmission 112 (FIG. 1).

As indicated at block 410, the method may include receiving a video signal from a video source. For example, receiver 106 (FIG. 1) may receive video signal 104 (FIG. 1), e.g., as described above.

As indicated at block 420, the method may also include generating a plurality of data components corresponding to the video signal. For example, coefficient generator 151 (FIG. 1) may generate data components 136 (FIG. 1) including a plurality of transform coefficients, e.g., as described above.

As indicated at block 430, the method may include associating the plurality of data components with a plurality of importance levels. For example, coefficient generator 151 (FIG. 1) may generate indication1 137 (FIG. 1) to indicate the importance levels associated with components 136 (FIG. 1), e.g., as described above.

As indicated at block 440, the method may include applying an UEP scheme to the data components. For example, UEP coder 114 (FIG. 1) may apply the UEP scheme to protect data components based on the plurality of importance levels, e.g., as described above.

As indicated at block 450, the method may include transmitting a wireless video transmission including the data components protected according to the UEP scheme. For example, transmitter 106 (FIG. 1) may transmit transmission 112 (FIG. 1), e.g., as described above.

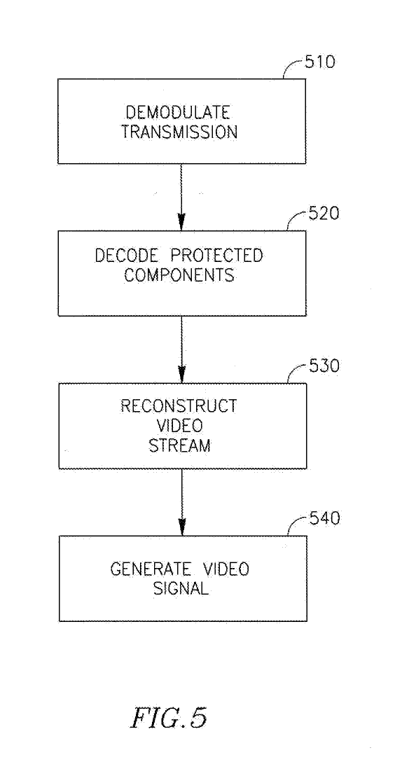

Reference is now made to FIG. 5, which schematically illustrates a method of handling a received wireless video transmission, in accordance with some demonstrative embodiments of the invention. Although embodiments of the invention are not limited in this respect, one or more operations of the method of FIG. 5 may be performed by a receiver, e.g. transmitter 124 (FIG. 1), and/or a UEP decoder, e.g., UEP decoder 128 (FIG. 1), to generate a video signal, e.g., video signal 146 (FIG. 1) based on a received wireless video transmission, e.g., transmission 112 (FIG. 1).

As indicated at block 510, the method may include demodulating the received transmission, e.g., into a plurality of data components. For example, demodulator 128 (FIG. 1) may demodulate transmission 112 (FIG. 1) to generate data components 130, e.g., as described above.

As indicated at block 520, the method may also include decoding the protected data components in accordance with the UEP scheme. For example, UEP decoder 140 (FIG. 1) may decode data components 130 (FIG. 1) in accordance with the UEP scheme applied by transmitter 106 (FIG. 1), e.g., as described above. The decoding of the data components may include, for example, performing error detection and/or error correction to handle errors in the received transmission, e.g., as described above.

As indicated at bock 530, the method may also include reconstructing a video stream based on the data components. For example, receiver 124 (FIG. 1) may reconstruct a video stream based on data components 142 (FIG. 1). Reconstructing the video stream may include, for example, performing suitable de-correlating transform operations and/or color component conversion operations, e.g., as described in the '641 application.

As indicated at block 540, the method may include generating a video signal based on the data components of the received transmission. For example, receiver 124 (FIG. 1) may generate video signal 146 (FIG. 1) based on transmission 112 (FIG. 1), e.g., as described above.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. A wireless transmitter to transmit a wireless transmission including a data stream corresponding to at least a video signal, said data stream including a plurality of data components, which are protected according to an unequal error protection scheme, wherein at least first and second data components of said plurality of data components are protected by first and second error protection mechanisms, respectively.

2. The wireless transmitter of claim 1, wherein said first and second error protection mechanisms comprise first and second types of error correction codes, respectively.

3. The wireless transmitter of claim 2, wherein the error correction code of said first type is stronger than the error correction code of said second type.

4. The wireless transmitter of claim 2, wherein said first and second types of error correction codes comprise error correction codes of first and second rates, respectively.

5. The wireless transmitter of claim 1, wherein said first and second error protection mechanisms correspond to first and second different modulation schemes.

6. The wireless transmitter of claim 5, wherein said first and second modulation schemes include first and second different numbers of constellation points.

7. The wireless transmitter of claim 1, wherein said first protection mechanism allows recovery of a larger number of erroneous bits than said second protection mechanism.

8. The wireless transmitter of claim 1, wherein said first component comprises a plurality of most-significant bits of a value corresponding to said video signal, and wherein said second component comprises a plurality of least-significant-bits of said value.

9. The wireless transmitter of claim 1, wherein a degree of protection provided by said first error protection mechanism is higher than a degree of protection provided by said second error protection mechanism.

10. The wireless transmitter of claim 9, wherein an importance level of said first data component is higher than an importance level of said second data component.

11. The wireless transmitter of claim 1, wherein said first data component comprises a quantized value of a transformation coefficient corresponding to said video signal, and wherein said second data component comprises a quantization-error value corresponding to said quantized value.

12. The wireless transmitter of claim 1, wherein at least one of said first and second data components is protected by a full error correction mechanism.

13. The wireless transmitter of claim 1, wherein at least one of said first and second data components is protected by a partial error correction mechanism.

14. The wireless transmitter of claim 1, wherein at least one of said first and second data components is protected by an error detection mechanism.

15. The wireless transmitter of claim 1, wherein said plurality of data components comprise de-correlation components resulting from applying a de-correlation transformation to said video signal.

16. The wireless transmitter of claim 15, wherein said de-correlation transformation comprises at least one of a discrete cosine transform and a wavelet.

17. The wireless transmitter of claim 1, wherein said first and second data components are encrypted according to at least one encryption scheme.

18. The wireless transmitter of claim 16, wherein said first and second data components are encrypted according to first and second different encryption schemes, respectively.

19. The wireless transmitter of claim 1, wherein said video signal comprises a high-definition-television video signal.

20. The wireless transmitter of claim 19, wherein said high-definition-television video signal comprises an uncompressed high-definition-television video signal.

21. The wireless transmitter of claim 1, wherein said wireless transmission comprises a multiple-input-multiple-output transmission.

22. The wireless transmitter of claim 1, wherein said wireless transmission comprises an orthogonal-frequency-division-multiplexing transmission.

23. A system comprising:
a video source to generate a video signal; and
a wireless transmitter to transmit a wireless transmission including a data stream corresponding to said video signal, said data stream including a plurality of data components, which are protected according to an unequal error protection scheme, wherein first and second data components of said plurality of data components are protected by first and second error protection mechanisms, respectively.

24. The system of claim 23 comprising:
a video destination; and
a wireless receiver to receive said wireless transmission and to provide said video destination with an input corresponding to the transmitted video signal.

25. The system of claim 23, wherein said first and second error protection mechanisms comprise first and second types of error correction codes, respectively.

26. The system of claim 23, wherein said first and second error protection mechanisms correspond to first and second different modulation schemes.

27. The system of claim 23, wherein said first protection mechanism allows recovery of a larger number of erroneous bits than said second protection mechanism.

28. The system of claim 23, wherein said first component comprises a plurality of most-significant bits of a value corresponding to said video signal, and wherein said second component comprises a plurality of least-significant-bits of said value.

29. The system of claim 23, wherein a degree of protection provided by said first error protection mechanism is higher than a degree of protection provided by said second error protection mechanism.

30. The system of claim 23, wherein said first and second data components are encrypted according to at least one encryption scheme.

31. The system of claim 23, wherein said video signal comprises a high-definition-television video signal.

32. A wireless receiver to receive a wireless transmission including a data stream representing a video signal and to generate an output corresponding to the transmitted video signal, said data stream including a plurality of data components, which are protected according to an unequal error protection scheme, wherein first and second data components of said plurality of data components are protected by first and second error protection mechanisms, respectively.

33. The wireless receiver of claim 32, wherein said first and second error protection mechanisms comprise first and second types of error correction codes, respectively.

34. The wireless receiver of claim 32, wherein said first and second error protection mechanisms correspond to first and second different modulation schemes.

35. The wireless receiver of claim 32, wherein said first component comprises a plurality of most-significant bits of a value corresponding to said video signal, and wherein said second component comprises a plurality of least-significant-bits of said value.

36. The wireless receiver of claim 32, wherein said first and second data components are encrypted according to at least one encryption scheme, and wherein said receiver is to decrypt said first and second data components.

37. The wireless receiver of claim 32, wherein said video signal comprises a high-definition-television video signal.

38. A method comprising transmitting a wireless transmission including a data stream corresponding to a video signal, said data stream including a plurality of data components, which are protected according to an unequal error protection scheme, wherein first and second data components of said plurality of data components are protected by first and second error protection mechanisms, respectively.

39. The method of claim 38 comprising:
receiving said wireless transmission; and
generating an output corresponding to the transmitted video signal.

40. The method of claim 38, wherein said first and second error protection mechanisms comprise first and second types of error correction codes, respectively.

41. The method of claim 38, wherein said first and second error protection mechanisms correspond to first and second different modulation schemes.

42. The method of claim 38, wherein said first component comprises a plurality of most-significant bits of a value corresponding to said video signal, and wherein said second component comprises a plurality of least-significant-bits of said value.

43. The method of claim 38 comprising encrypting said first and second data components according to at least one encryption scheme.
